(19) United States
(12) Patent Application Publication
(10) Pub. No.: US 2008/0226988 A1
(43) Pub. Date: Sep. 18, 2008

(54) Nonaqueous electrolyte secondary battery

(76) Inventors: Hiroshi Minami, Osaka (JP); Naoki Imachi, Osaka (JP)

Correspondence Address: KUBOVCIK & KUBOVCIK, SUITE 1105, 1215 SOUTH CLARK STREET, ARLINGTON, VA, 22202, US

(21) Appl. No.: 12/073,882

(22) Filed: Mar. 11, 2008

(30) Foreign Application Priority Data
Mar. 12, 2007 (JP) 62108/2007

(51) Int. Cl. H01M 4/48

(52) U.S. Cl. 429/231.5; 429/218.1

(57) ABSTRACT

To obtain a nonaqueous electrolyte secondary battery which has excellent storage characteristics at elevated temperatures, and can inhibit an increase in battery resistance and a reduction in charge-discharge efficiency after storage, and can enhance safety. A nonaqueous electrolyte secondary battery having a negative electrode including a negative active material, a positive electrode including a positive active material, a nonaqueous electrolyte and a separator placed between the negative electrode and the positive electrode, wherein an inorganic particle layer including an inorganic particle which does not occlude and release lithium, a conductive material and a binder is placed on the surface of the negative electrode, and an electrically conducting path contacting with the surface of the negative electrode is formed in the inorganic particle layer by the conductive material.

### BACKGROUND OF THE INVENTION

1. Field of the Invention

The present invention relates to a nonaqueous electrolyte secondary battery.

2. Description of the Related Art

In recent years, the downsizing and weight reduction of mobile terminal devices such as a mobile phone, a notebook computer, a PDA and the like moves forward rapidly, and batteries as a drive power source of these mobile terminal devices are required to become a further high capacity. Development of higher capacity of a lithium ion secondary battery having a high energy density among secondary batteries is progressing year after year. Further, in these mobile terminal devices, entertainment functions such as a moving video replay, a game function and the like are increasingly enriched and power consumption tends to increase, and therefore it is strongly desired that the lithium ion battery as a drive power source has a higher capacity and high performance for a prolonged replay or an output improvement.

The conventional developments of a higher capacity lithium ion secondary battery have focused on making members such as a battery case, a separator and a collector (aluminum foil or copper foil) which are not concerned in electrical power generation components thinner and making a density of an active material higher (improvement of the packing density of an electrode). However, these countermeasures are almost approaching the limit and future countermeasures for achieving a higher capacity require essential material changes. However, as for achieving a higher capacity by the active material, in positive active materials, there is little material which has a higher capacity than lithium cobalt oxide and has the same performance or higher than lithium cobalt oxide. On the other hand, in negative active materials, negative electrodes of alloy of Si, Sn or the like are expected.

A theoretical capacity of lithium cobalt oxide is about 273 mAh/g, and just about 160 mAh/g of the theoretical capacity is used when an end-of-charge voltage is 4.2 V. By raising the end-of-charge voltage to 4.4 V, a capacity can be used up to about 200 mAh/g and it is possible to achieve a higher capacity by about 10% as a whole battery. However, when the battery is used at a high voltage, the oxidation power of the charged positive active material is increased, and therefore not only the decomposition of the electrolyte solution is accelerated, but also the stability of a crystal structure of the positive active material itself, from which lithium is extracted, is lost, and cycle deterioration or storage deterioration due to the decay of crystal becomes a problem.

In the battery in which the end-of-charge voltage is raised, the stability of a crystal structure of the positive active material is lost as described above. Particularly, the reduction in a battery performance at elevated temperatures becomes remarkable. Though a detailed cause for this is not clear, in accordance with the investigation of the present inventors, it is estimated that a resolvent of the electrolyte solution or elements eluted from the positive active material (when lithium cobalt oxide was used, the elution of cobalt was observed) were observed and these resolvent and elements are main factors for the reduction in storage characteristics in storing a battery at elevated temperatures.

Particularly, in battery systems using a positive active material such as lithium cobalt oxide, lithium manganese oxide or lithium complex oxide of nickel-cobalt-manganese, the precipitation of Co or Mn on a negative electrode or a separator due to the storage deterioration at elevated temperatures has been observed, and these elements eluted as an ion are precipitated on the negative electrode by being reduced, and this causes problems such as an increase in internal resistance and hence a reduction in a capacity. When the end-of-charge voltage of the lithium ion secondary battery is raised, the instability of a crystal structure increases and these phenomena tend to increase even at a temperature near 50° C. where there was previously no problem in a battery system of 4.2 V specification.

For example, in the battery system in which the end-of-charge voltage of 4.4 V is selected, when a storage test is performed at 60° C. for 5 days in a combination of the active materials of lithium cobalt oxide and graphite, a residual capacity is significantly reduced and may be reduced to almost zero. This battery was disassembled, and consequently a large amount of cobalt (Co) was detected from the negative electrode and separator, and therefore it is thought that elements eluted from the positive electrode accelerated a deterioration mode. It is estimated that this deterioration results from that a valence of the positive active material having a layered structure increases by extracting a lithium ion, but a Co ion is apt to elute from a crystal because tetravalent cobalt is unstable and therefore a crystal itself is not stable and tends to change to a stable structure. When a structure of the charged positive active material is unstable like this, particularly, storage deterioration or cycle deterioration at elevated temperatures tends to become remarkable. It has also been proved that the higher the packing density of the positive electrode, the more this tendency occurs. This tendency is an issue to be solved particularly in a battery of high capacity design. It is estimated that the reason why properties of the separator are concerned in the storage deterioration is that substances reduced at the negative electrode are deposited and fill fine multiple pores of the separator.

Further, when spinel type lithium manganese oxide is used as the positive active material, there is a problem that even if the end-of-charge voltage is 4.2 V, Mn or the like is eluted from the positive active material and the cycle deterioration or storage deterioration occurs due to the eluted Mn.

The present inventors have found that it is effective to place an inorganic particle layer made of alumina or the like on the surface of the negative electrode as a method of inhibiting the above-mentioned storage deterioration or cycle deterioration at elevated temperatures. By placing the inorganic particle layer on the surface of the negative electrode, an eluted substance from the positive active material or a resolvent of the electrolyte solution can be trapped, and storage characteristics at elevated temperatures can be significantly improved. However, when the eluted substance from the positive electrode or the resolvent is deposited on the surface of the inorganic particle on the surface of the negative electrode, a problem that battery resistance after a storage test increases because of an increase in battery resistance arose. Further, if a deposit is so deposited as to cover the whole area of the inorganic particle layer in charging after the storage test, lithium reaches the surface of the negative active material and is precipitated on this deposit. Therefore, a reduction in charge-discharge efficiency or safety after a storage test becomes a problem.

Further, in the present invention, an inorganic particle layer is formed on the surface of the negative electrode. As a conventional technology of forming such an inorganic particle layer on an electrode, it is proposed to form a porous insulating layer on the surface of the positive or negative electrode to improve the safety against the insertion of nails in Patent Publication No. 3371301 and International Publication WO 2005/057691A1 pamphlet. Further, in Japanese Unexamined Patent Publication No. 2005-259467, it is proposed that projections and depressions are intentionally formed in a porous layer and thereby an electrolyte solution-absorbing property in a battery is improved. In Japanese Unexamined Patent Publication No. 2005-50779, lithium cobalt oxide containing Zr and Mg which are preferably employed in the present invention is disclosed.

### SUMMARY OF THE INVENTION

It is an object of the present invention to provide a nonaqueous electrolyte secondary battery which has excellent storage characteristics at elevated temperatures, and can inhibit an increase in battery resistance and a reduction in charge-discharge efficiency after storage, and can enhance safety.

The present invention pertains to a nonaqueous electrolyte secondary battery having a negative electrode including a negative active material, a positive electrode including a positive active material, a nonaqueous electrolyte and a separator placed between the negative and positive electrodes, wherein an inorganic particle layer including an inorganic particle which does not occlude and release lithium, a conductive material and a binder is placed on the surface of the negative electrode, and an electrically conducting path contacting with the surface of the negative electrode is formed in the inorganic particle layer by the conductive material.

In the present invention, the inorganic particle layer including the inorganic particle, the conductive material and binder is placed on the surface of the negative electrode, and the electrically conducting path contacting with the surface of the negative electrode is formed in the inorganic particle layer by the conductive material. Accordingly, the eluted substance from the positive electrode or the resolvent is selectively deposited on a portion, in which the electrically conducting path is formed, on the surface of the negative electrode, and this can prevent the eluted substance or the resolvent from being so deposited as to cover the whole area of the inorganic particle layer as with a conventional case. Therefore, the overall inorganic particle layer is not covered with the deposit, and lithium is not precipitated on the deposit. Therefore, lithium can pass through the inorganic particle layer not covered with the deposit and can be inserted into a negative active material layer.

In accordance with the present invention, since the whole surface of the negative electrode is not covered with the deposit, an increase in battery resistance can be inhibited and an increase in battery resistance after storage can be inhibited. Further, since the precipitation of lithium on the deposit can be inhibited, it is possible to inhibit a reduction in charge-discharge efficiency and enhance safety.

In the present invention, since the inorganic particle layer is formed on the surface of the negative electrode, a binder component contained in the inorganic particle layer absorbs a nonaqueous electrolyte to swell and therefore a moderate filtrating function is developed between the negative electrode and separator. Thereby, a resolvent of the nonaqueous electrolyte due to a reaction at the positive electrode or elements eluted from the positive active material (for example, cobalt ion, manganese ion, etc.) can be trapped to prevent these substances from precipitating on the surface of the negative electrode or on the separator. Further, it is also possible to mitigate damages to the negative electrode or the separator to limit the storage deterioration at elevated temperatures.

In accordance with the present invention, storage characteristics at elevated temperatures can be significantly improved by the above-mentioned filtrating function by the inorganic particle layer, and additionally an electrically conducting path contacting with the surface of the negative electrode can be formed by the conductive material in the inorganic particle layer to prevent the deposit from covering the overall inorganic particle. Further, the precipitation of lithium on the deposit can be prevented. Therefore, in accordance with the present invention, it is possible to inhibit the increase in battery resistance and the reduction in charge-discharge efficiency after storage, and enhance safety.

The inorganic particle layer in the present invention includes the inorganic particle which does not occlude and release lithium, the conductive material and the binder.

The conductive material included in the inorganic particle layer is not particularly limited as long as it is a material having conductivity, and examples of the material include carbon materials, metal fine particles, and the like. Examples of the carbon materials include acetylene black, Ketjen Black, vapor phase growth carbon fibers (VGCF) and the like. Examples of the metal fine particles include copper, nickel and the like, and metals in which a reduction reaction with lithium does not take place are preferably employed. A shape of the particle is not particularly limited, and any shape of spherical, fibriform, granulated shape, etc. may be used. An average particle diameter of the conductive material is preferably the thickness of the inorganic particle layer or less since the conductive material is contained in the inorganic particle layer, further preferably 4 μm or less, and furthermore preferably in a range of 1 nm to 1.0 μm. When the conductive material has a fibriform shape, an average fiber diameter is preferably 4 μm or less, and an average fiber length may be 4 μm or more, but it is preferably 50 μm or less. The average fiber diameter is more preferably in a range of 1 nm to 2.0 μm and the average fiber length is more preferably in a range of 1 to 50 μm.

Preferably, a BET specific surface area of the conductive material is 1.0 m²/g or more. As the conductive material has a larger surface area, it is possible to react the eluted substance from the positive electrode or the resolvent more at the surface of the conductive material and to inhibit the deposit more effectively from covering the overall inorganic particle layer. Further, by including the conductive material in the inorganic particle layer, it is possible to confine the eluted substance or the resolvent in the inorganic particle layer to inhibit the precipitation of lithium on the deposit. More preferable range of the BET specific surface area of the conductive material is 10 to 1000 m²/g.

As inorganic particles used for forming the inorganic particle layer, rutile type titanium oxide (rutile type titania), aluminum oxide (alumina), zirconium oxide (zirconia), magnesium oxide (magnesia), and the like can be used. An average particle diameter is preferably 1 μm or less, and furthermore preferably in a range of 0.1 to 0.8 μm. In consideration of the dispersibility in slurry, the inorganic particle, the surface of which is surface treated with Al, Si or Ti, is particularly preferable. An average particle diameter of the inorganic particle is preferably larger than an average pore size of the separator. By selecting the average particle diameter larger than the average pore size of the separator, the damages to the separator can be mitigated and the intrusion of the inorganic particle into fine multiple pores of the separator can be inhibited. In consideration of safety (i.e., reactivity with lithium) in the battery or cost, aluminum oxide and rutile type titanium oxide are particularly preferable.

A binder in the inorganic particle layer is not particularly limited in its material, but a material comprehensively satisfying characteristics such as (1) securing the dispersibility of the inorganic particle (prevention of reflocculating), (2) securing the adhesion to withstand a production process of a battery, (3) filling the gaps between the inorganic particles produced due to swelling after absorbing a nonaqueous electrolyte, and (4) low elution of a nonaqueous electrolyte is preferable. In order to secure battery performance, it is preferable to exert these characteristics in a small amount of the binder. Accordingly, the content of the binder in the inorganic particle layer is preferably 30 parts by weight or less with respect to 100 parts by weight of the total of the inorganic particle and the conductive material, more preferably 10 parts by weight or less, and furthermore preferably 5 parts by weight or less. A lower limit of an amount of the binder in the inorganic particle layer is commonly 0.1 part by weight. As a material of the binder, polytetrafluoroethylene (PTFE), polyvinylidene fluoride (PVDF), polyacrylonitrile (PAN), styrene-butadiene rubber (SBR), modified substances and derivatives thereof, copolymers including an acrylonitrile unit, polyacrylic acid derivatives, and the like are preferably used. Particularly when the above-mentioned characteristics (1) to (3) are highly regarded and met with a small amount of the binder material to be added, copolymers including an acrylonitrile unit are preferably employed.

Preferably, the content of the conductive material in the inorganic particle layer is within a range of 0.1 to 10% by weight of the total amount of the inorganic particle and the conductive material. When the content of the conductive material is less than 0.1% by weight, an effect of including the conductive material in the inorganic particle layer cannot be adequately obtained and the surface of the inorganic particle layer may be covered widely with the deposit. Further, when the content of the conductive material is more than 10% by weight, the dispersibility of the conductive material is deteriorated and the settling of slurry becomes intense.

A thickness of the inorganic particle layer is preferably 4 μm or less, furthermore preferably in a range of 0.5 to 4 μm, and particularly preferably in a range of 0.5 to 2 μm. If the thickness of the inorganic particle layer is too small, an effect achieved by forming the inorganic particle layer may become inadequate, and if the thickness of the inorganic particle layer is too large, load characteristics of the battery may reduce, or an energy density of the battery may be reduced.

As a solvent used in preparing slurry for forming the inorganic particle layer, N-methylpyrrolidone (NMP), cyclohexanone, water, or the like can be used besides acetone, but the solvent is not limited to these. As for a method of dispersing slurry, wet dispersion methods such as FILMICS manufactured by Tokushu Kika Kogyo Co., Ltd., and a bead mill type are suitable. Dispersion methods used for dispersion of a coating material are preferably used particularly because a particle size of the inorganic particle used in the present invention is small, and settling of slurry is intense and a uniform film cannot be formed if the slurry is not mechanically dispersed.

Examples of a method of forming the inorganic particle layer on the negative electrode include a die coating method, a gravure coating method, a dip coating method, a curtain coating method, a spray coating method, and the like. Particularly, the gravure coating method and the die coating method are preferably employed. Further, in consideration of the reduction in adhesive strength due to the diffusion of a solvent or a binder into the electrode, a method, in which the slurry can be applied quickly and the solvent is evaporated in short time, is desirable. The concentration of solid matter in the slurry varies greatly depending on a coating method. In the case of the spray coating method, the dip coating method or the curtain coating method in which a thickness of the layer cannot be mechanically controlled, it is preferable that the concentration of solid matter is low and is in a range of 3 to 30% by weight. In addition, in the case of the die coating method or the gravure coating method, the concentration of solid matter may be high or may be low, and is preferably about 5 to 70% by weight.

The positive active material to be used in the present invention has a layered structure. Particularly, lithium-containing transition metal oxide having a layered structure is preferably employed. Examples of the lithium transition metal oxide include lithium complex oxides containing cobalt or manganese such as lithium cobalt oxide, lithium complex oxide of cobalt-nickel-manganese, lithium complex oxide of aluminum-nickel-manganese and lithium complex oxide of aluminum-nickel-cobalt. Particularly, a positive active material, in which a capacity is increased by setting the end-of-charge potential of the positive electrode at 4.30 V (vs. Li/Li⁺) or more, is preferably used. The positive active materials may be used singly or as a mixture with another positive active material.

It is known that lithium cobalt oxide has a crystal structure which becomes instable as charge depth is enhanced. Therefore, when lithium cobalt oxide is used, it is preferable to add Zr and Mg to the lithium cobalt oxide in advance. By adding Zr and Mg, stable charge-discharge cycle characteristics can be attained. An amount of Zr to be added is preferably in a range of 0.01 to 3.0 mol % of the total amount of metal elements other than lithium in lithium cobalt oxide. An amount of Mg to be added is preferably in a range of 0.01 to 3.0 mol % of the total amount of metal elements other than lithium in lithium cobalt oxide. It is preferable to include Zr with Zr adhering to the surface of lithium cobalt oxide in the form of a particle as disclosed in Japanese Unexamined Patent Publication No. 2005-50779. By adding Zr and Mg within these ranges, stable charge-discharge cycle characteristics can be attained.

Further, when lithium cobalt oxide is used at a high end-of-charge potential, a capacity increases but thermal stability is deteriorated. By adding Al to lithium cobalt oxide, thermal stability can be enhanced. Preferably, an amount of Al to be added is in a range of 0.01 to 3.0 mol % of the total amount of metal elements other than lithium in lithium cobalt oxide.

Accordingly, it is preferable to add Zr, Mg and Al to lithium cobalt oxide to be used in the present invention.

The negative active material used in the present invention is not particularly limited, and a substance which can be used as a negative active material of the nonaqueous electrolyte secondary battery can be used. Examples of the negative active material include carbon materials such as graphite, cokes and the like, metal oxides such as tin oxide and the like, metals, which can occlude lithium by being alloyed with lithium, such as silicon, tin and the like, and metal lithium. As the negative active material in the present invention, particularly, carbon materials such as graphite and the like are preferably employed.

In the nonaqueous electrolyte secondary battery of the present invention, it is preferable to charge a battery in such a way that the end-of-charge potential of the positive electrode becomes 4.30 V (vs. Li/Li⁺) or more as described above. Since the battery is charged in such a way that the end-of-charge potential of the positive electrode is higher than a conventional potential like this, the charge-discharge capacity can be raised. Further, by raising the end-of-charge potential of the positive electrode, a transition metal Co or Mn is easily eluted from the positive active material, but the present invention can inhibit the Co or Mn thus eluted from depositing directly on the surface of the negative electrode to deteriorate the storage characteristics at elevated temperatures.

Further, the nonaqueous electrolyte secondary battery of the present invention has excellent storage characteristics at elevated temperatures, and it can exert its effect outstandingly by using it, for example, for a nonaqueous electrolyte secondary battery whose operating environment is 50° C. or higher.

In the present invention, a battery is preferably charged in such a way that the end-of-charge potential of the positive electrode more preferably becomes 4.35 V (vs. Li/Li⁺) or more, and furthermore preferably becomes 4.40 V (vs. Li/Li⁺) or more. When a carbon material is used as a negative active material, the end-of-charge potential of the negative electrode is about 0.1 V (vs. Li/Li⁺), and therefore the end-of-charge voltage is 4.20 V in the case where the end-of-charge potential of the positive electrode is 4.30 V (vs. Li/Li⁺), and the end-of-charge voltage is 4.30 V in the case where the end-of-charge potential of the positive electrode is 4.40 V (vs. Li/Li⁺).

In addition, it has been found that if the end-of-charge potential of the positive electrode is set at 4.35 V (vs. Li/Li⁺) or more, a residual ratio of the battery capacity is sharply reduced in a storage test of 60° C. The reason for this is estimated that when the end-of-charge potential of the positive electrode is high, since a solute such as Co or the like eluted from the positive active material increases and a decomposition reaction of the electrolyte solution occurs more, a residual ratio of the capacity reduces as the end-of-charge potential of the positive electrode increases.

As a solvent of the nonaqueous electrolyte to be used in the present invention, a substance which is hitherto used as a solvent for an electrolyte of a lithium secondary battery can be used. Among others, a mixture solvent of cyclic carbonate and chain carbonate is particularly preferably used. Specifically, it is preferable that a mixing ratio between the cyclic carbonate and the chain carbonate (cyclic carbonate: chain carbonate) is in the rage of 1:9 to 5:5.

Examples of the cyclic carbonates include ethylene carbonate, propylene carbonate, butylene carbonate, and vinylene carbonate. Examples of the chain carbonates include dimethyl carbonate, methyl ethyl carbonate, and diethyl carbonate.

Further, a mixture solvent of the above-mentioned cyclic carbonate and an ether solvent such as 1,2-dimethoxyethane or 1,2-diethoxyethane may be used.

As a solute of the nonaqueous electrolyte to be used in the present invention, LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀ and Li₂B₁₂Cl₁₂, and mixtures thereof are exemplified. Particularly, at least one species selected from the group consisting of LiXF_{y} (wherein X represents an element P, As, Sb, B, Bi, Al, Ga, or In, and when X is P, As, or Sb, y is an integer of 6, and when X is B, Bi, Al, Ga, or In, y is an integer of 4), lithium(perfluoroalkylsulfonyl)imide LiN(CₘF₂ₘ₊₁SO₂)(CₙF₂ₙ₊₁SO₂) (where in m and n are each independently an integer of 1 to 4), and lithium(perfluoroalkylsulfonyl)methide LiC(CₚF₂ₚ₊₁SO₂)(C_{q}F_{2q+1}SO₂)(CrF₂ᵣ₊₁SO₂) (wherein p, q and r are each independently an integer of 1 to 4) is preferably used.

Further, as an electrolyte, a polymer electrolyte in gel form formed by impregnating a polymer electrolyte such as polyethyleneoxide or polyacrylonitrile with an electrolyte solution, or an inorganic solid electrolyte such as LiI or Li₃N may be used.

The electrolyte of the nonaqueous electrolyte secondary battery of the present invention can be used without limits as long as a lithium compound as a solvent exerting ionic conductivity and a solvent to dissolve and retain this lithium compound are not decomposed by a voltage in charging or discharging the battery or in storing the battery.

In the present invention, preferably, a ratio (negative electrode charge capacity/positive electrode charge capacity) of a charge capacity of the negative electrode to a charge capacity of the positive electrode is in a range of 1.0 to 1.1. By setting the ratio between charge capacities of the negative electrode and the positive electrode at 1.0 or more, the precipitation of metal lithium on the surface of the negative electrode can be prevented. Therefore, the cycle characteristics and the safety of the battery can be enhanced. Further, when the ratio between charge capacities of the negative electrode and the positive electrode is more than 1.1, it may be unfavorable since an energy density per volume is reduced. In addition, such a ratio between charge capacities of the negative electrode and the positive electrode is set in response to an end-of-charge voltage of a battery.

In accordance with the present invention, it is possible to form a nonaqueous electrolyte secondary battery which has excellent storage characteristics at elevated temperatures, and can inhibit an increase in battery resistance and a reduction in charge-discharge efficiency after storage, and can enhance safety.

### BRIEF DESCRIPTION OF THE DRAWINGS

FIG. 1 is a sectional view schematically showing a negative electrode of an embodiment according to the present invention;

FIG. 2 is a sectional view schematically showing a conventional negative electrode for comparison;

FIG. 3 is a scanning electron micrograph (magnification 3000 times) showing the surface of the negative electrode after the storage test of a battery T2 according to the present invention; and

FIG. 4 is a scanning electron micrograph (magnification 5000 times) showing the surface of the negative electrode after the storage test of a battery R1 for comparison.

### DETAILED DESCRIPTION OF THE PREFERRED EMBODIMENT

Hereinafter, the present invention will be described in more detail, but the present invention is not limited to the following embodiments, and variations may be appropriately made without changing the gist of the present invention.

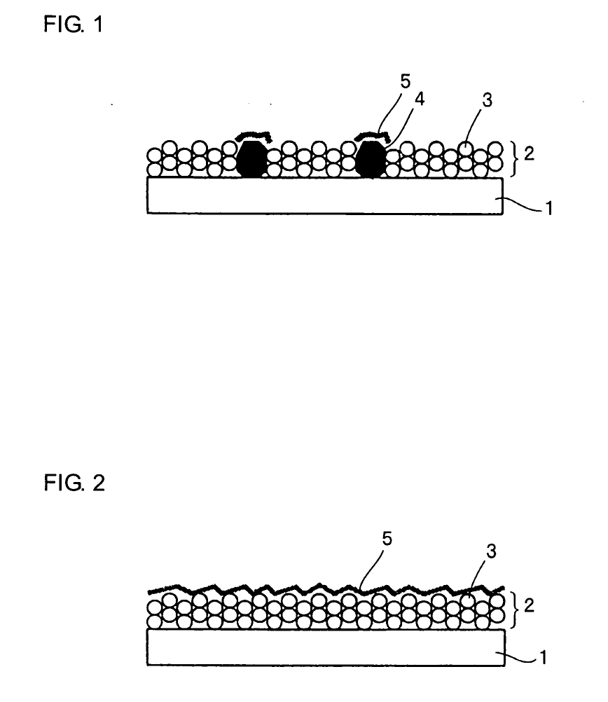

FIG. 1 is a sectional view schematically showing a negative electrode of an embodiment according to the present invention. As illustrated in FIG. 1, an inorganic particle layer 2 is placed on a negative electrode 1. The inorganic particle layer 2 contains inorganic particles 3 and a conductive material 4. The conductive material 4 contacts with the surface of the negative electrode 1 and an electrically conducting path is formed in the inorganic particle layer 2 by the conductive material 4.

Co or Mn eluted from the positive active material in storing a battery at elevated temperatures generally tends to deposit on the negative electrode 1, but in the present invention, the direct deposition of Co or Mn on the negative electrode 1 can be prevented because the inorganic particle layer 2 is place on the negative electrode 1. Further, since the inorganic particle layer 2 contains the conductive material 4 and the electrically conducting path is formed by this conductive material 4, an eluted substance from the positive electrode or a resolvent reacts at the surface of the conductive material 4 to deposit a deposit 5 on the conductive material 4.

FIG. 2 is a schematic sectional view showing a conventional negative electrode, and an inorganic particle layer 2 is placed on a negative electrode 1, but the inorganic particle layer 2 does not contain a conductive material 4. In such an electrode, a deposit 5 is deposited on the whole surface of the inorganic particle layer 2. Therefore, the plate resistance of the negative electrode increases and the battery resistance after a storage test increases to cause load deterioration. Further, since the deposit 5 is deposited on the whole area of the inorganic particle layer 2, lithium does not reach the surface of the negative active material of the negative electrode 1 in charging, and lithium is precipitated on the deposit 5. Thereby, the reduction in charge-discharge efficiency or safety after a storage test occurs.

By including the conductive material 4 in the inorganic particle layer 2 according to the present invention, it is possible to deposit the deposit 5 selectively on the surface of the conductive material 4 to prevent the deposit 5 from being deposited on the whole surface of the inorganic particle layer 2. Accordingly, it is possible to inhibit the increase in battery resistance and the reduction in charge-discharge efficiency after storage and enhance safety.

In Examples and Comparative Examples described later, by following the procedure described below, a positive electrode, a negative electrode, an inorganic particle layer, and a nonaqueous electrolyte solution were prepared, and a nonaqueous electrolyte secondary battery was assembled.

### [Preparation of Positive Electrode]

A positive active material, acetylene black which is a carbon-conductive material, and polyvinylidene fluoride (PVDF) were mixed so as to be a mass ratio of 95:2.5:2.5, and the resulting mixture was stirred in N-methylpyrrolidone (NMP) as a solvent with a kneader to prepare slurry for forming a positive electrode. This slurry was applied onto both sides of aluminum foil, and dried, and the aluminum foil coated with the slurry was rolled to form an electrode.

### [Preparation of Negative Electrode}

Graphite, sodium carboxymethyl cellulose (CMC) and styrene-butadiene rubber (SBR) were mixed in an aqueous solution so as to be a mass ratio of 98:1:1, and the resulting mixture was applied onto both sides of copper foil which is a collector, and then dried, and the copper foil coated with the mixture was rolled to form an electrode. A packing density of the negative active material was set at 1.60 g/ml.

### [Preparation of Inorganic Particle Layer]

Using NMP as a solvent, titanium oxide (rutile type, average particle diameter 0.38 μm, “KR 380” produced by Titan Kogyo, Co., Ltd.) and a conductive material (used in only Examples) were mixed in such a way that the concentration of solid matter was 10% by weight, and in the resulting mixture, a copolymer (rubber-like polymer) including an acrylonitrile structure (unit) was mixed in such a way that the content of the copolymer was 2.5 parts by weight with respect to 100 parts by weight of the total of titanium oxide and the conductive material. The resulting mixture was mixed/dispersed with a bead mill type kneader to prepare slurry in which titanium oxide is dispersed. This slurry was applied onto the surface of the negative electrode by a gravure coating process and the solvent was evaporated to be removed to form an inorganic particle layer on the surface of the negative electrode.

### [Preparation of Nonaqueous Electrolyte Solution]

As an electrolyte solution, a solution, which was prepared by dissolving LiPF₆ in a mixture solvent formed by mixing ethylene carbonate (EC) and diethyl carbonate (DEC) in proportions of 3:7 by volume in such a way that the concentration of LiPF₆ in the solvent was 1 mol/liter, was used.

### [Assembly of Battery]

A lead terminal was attached to each of the positive and negative electrodes, and the positive electrode, the negative electrode, and a separator were rolled in a spiral fashion with the separator interposed therebetween. This rolled article was pressed to prepare an electrode body flattened out. This electrode body was put in a battery case of aluminum-laminate, and an electrolyte solution was poured in the case, and the battery case was sealed to fabricate a secondary battery. Incidentally, a design capacity of the battery is 780 mAh. The design capacity of the battery was determined based on an end-of-charge voltage of 4.4 V. Further, an average pore size of the separator used was 0.1 μm, a thickness was 16 μm, and a void fraction was 47%.

In Examples and Comparative Examples described later, each battery was evaluated according to the following procedures.

### <Evaluation of Battery>

### [Charge-Discharge Test]

A constant current charge was performed at 1 C (750 mA) of current until a voltage reached 4.4V, and a charge was performed at a constant voltage of 4.4 V until a current reached 0.05 C (37.5 mA).

Further, a constant current discharge was performed at 1 C (750 mA) of current until a voltage reached 2.75 V.

An interval between the charge and the discharge was set at 10 minutes.

### [Storage Test at 60° C.]

A battery, which had been charged to a set voltage again by performing a charge-discharge cycle once under the above-mentioned condition of 1 C rate in accordance with design, was left standing at 60° C. for 5 days. Thereafter, the battery was cooled to room temperature, and a discharge was performed at 1 C of current, and then the charge-discharge cycle test was performed again at 1 C of current. From a discharge capacity before the storage test and the first discharge capacity after the storage test, a residual ratio of the discharge capacity was calculated by the following equation.

Residual ratio(%)=(the first discharge capacity after storage test/discharge capacity before storage test)×100

After the residual ratio was measured, a charge-discharge cycle was performed under the above-mentioned conditions to determine charge-discharge efficiency at the first charge-discharge cycle.

Further, battery resistance at 1 kHz was measured before and after the storage test to determine the increment between battery resistances before and after a storage test.

### Example 1

Using lithium cobalt oxide as a positive active material and artificial graphite as a negative active material, a positive electrode and a negative electrode were fabricated by the method described above. Lithium cobalt oxide containing Al and Mg in an amount 1 mol %, respectively, and Zr in an amount 0.05 mol % was used as the above lithium cobalt oxide. Incidentally, Zr adhered to the surface of lithium cobalt oxide in the form of a particle.

A battery was designed in such a way that the end-of-charge voltage becomes 4.40 V (4.50 V (vs. Li/Li⁺) as the end-of-charge potential of the positive electrode), and was designed at this potential in such a way that a ratio between charge capacities of the negative and positive electrodes (the first negative electrode charge capacity/the first positive electrode charge capacity) becomes 1.08. A packing density of the positive electrode was set at 3.60 g/ml.

An inorganic particle layer was formed on the surface of the negative electrode in the same manner as in the above description. Using vapor phase growth carbon fibers (VGCF produced by SHOWA DENKO K.K., BET specific surface area 13 m²/g, average fiber diameter 150 nm, average fiber length 15 to 20 μm) as the conductive material, titanium oxide and VGCF were mixed in a weight ratio of 58:2, and the resulting mixture was diluted with NMP in such a way that the concentration of solid matter was 10% by weight (the content of the binder was 2.5 parts by weight with respect to 100 parts by weight of the total of titanium oxide and VGCF) to prepare slurry, and this slurry was applied onto the surface of the negative electrode to form an inorganic particle layer. The inorganic particle layer was formed so as to be 2 μm in a thickness per a side and 4 μm in a thickness per both sides. This battery was taken as a battery T1 of the present invention.

### Example 2

A battery was prepared in the same manner as in Example 1 except for using acetylene black (produced by DENKI KAGAKU KOGYO K.K., trade name “HS-100”, BET specific surface area 37 m²/g, average particle diameter 3.30 μm) in place of VGCF as the conductive material. This battery was taken as a battery T2 of the present invention.

### Comparative Example 1

A battery was prepared in the same manner as in Example 1 except for not forming the inorganic particle layer on the surface of the negative electrode. This battery was taken as a battery R1 for comparison.

### Comparative Example 2

A battery was prepared in the same manner as in Example 1 except for not adding the conductive material to the inorganic particle layer. This battery was taken as a battery R2 for comparison.

The residual ratios, the increments between battery resistances before and after a storage test and the charge-discharge efficiency after storage test of the batteries T1 and T2 and the batteries R1 and R2 are shown in Table 1.

TABLE 1

| | | | | Increment | |
|---|---|---|---|---|---|
| | | | | between | Charge- |
| | | | | Battery | discharge |
| | | | | Resistances | Efficiency |
| | | | | before | after |
| | Inorganic Particle Layer | | Residual | and after | Storage |
| | Inorganic | Conductive | Ratio | Storage Test | Test |
| Battery | Particle | Material | (%) | (mΩ) | (%) |
| T1 | TiO₂ | VGCF | 77.6 | 16.4 | 97.8 |
| T2 | TiO₂ | HS-100 | 78.4 | 15.3 | 99.0 |
| R1 | — | — | 15.8 | 14.3 | 65.6 |
| R2 | TiO₂ | — | 71.3 | 31.0 | 92.3 |

As is apparent from the comparison between the batteries T1, T2, and R2 shown in Table 1, by adding the conductive material to the inorganic particle layer according to the present invention, a residual ratio can be improved, and the increment between battery resistances before and after the storage test can be reduced to improve the charge-discharge efficiency after the storage test. The reason for this is that by adding the conductive material to the inorganic particle layer, it is possible to deposit the eluted substance from the positive electrode and the resolvent selectively on the conductive material in the inorganic particle layer and it is possible to prevent the eluted substance and the resolvent from so depositing as to cover the overall inorganic particle layer. The eluted substance from the positive electrode or the resolvent is reduced/decomposed at the surface of the conductive material by the conductive material contacting with the surface of the negative electrode, and so deposited as to cover the conductive material. Therefore, it is possible to prevent the eluted substance from the positive electrode or the resolvent from so depositing as to cover the overall inorganic particle layer.

Thereby, a location through which lithium passes is secured and an increase in battery resistance can be inhibited and further an amount of lithium to be precipitated on the deposit can be significantly reduced. Therefore, the charge-discharge efficiency can be improved.

The batteries T2 and R1 after the storage test were disassembled and the negative electrodes were taken out, and the surface of each negative electrode was observed by a scanning electron microscope (SEM).

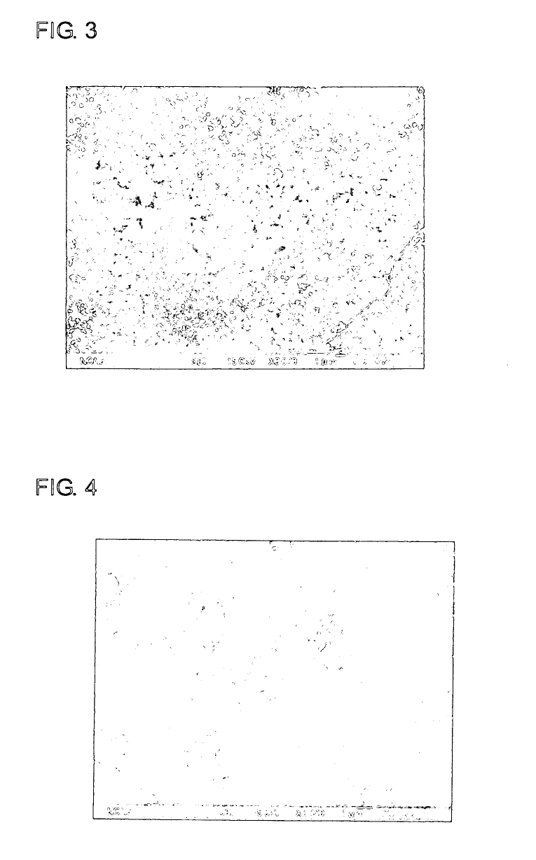

FIG. 3 is a scanning electron micrograph showing the surface of the negative electrode after the storage test of the battery T2, and FIG. 4 is a scanning electron micrograph showing the surface of the negative electrode after the storage test of the battery R1.

In the battery R1 in which the inorganic particle layer is not placed on the surface of the negative electrode, it is observed that the deposit is deposited over a large area of the surface of the negative electrode to cover the surface of the negative electrode. In addition, a portion looking white indicates the deposit in the micrograph.

On the other hand, in the battery T2 in which the inorganic particle layer containing the conductive material is placed on the surface of the negative electrode, the deposit is deposited in the vicinity of the conductive material existing locally and does not cover the overall inorganic particle layer. In addition, a black portion indicates the conductive material and a white portion in particle form thereon indicates the deposit in the micrograph. It was also understood from the above-mentioned scanning electron micrograph that by adding the conductive material to the inorganic particle layer according to the present invention, it is possible to deposit the deposit locally on the inorganic particle layer and prevent the deposit from covering the overall inorganic particle layer.

What is claimed is:

1. A nonaqueous electrolyte secondary battery comprising: a negative electrode including a negative active material; a positive electrode including a positive active material; a nonaqueous electrolyte; and a separator placed between said negative electrode and said positive electrode;
wherein an inorganic particle layer including an inorganic particle which does not occlude and release lithium, a conductive material and a binder is provided on the surface of said negative electrode, and an electrically conducting path contacting with the surface of said negative electrode is formed in said inorganic particle layer by said conductive material.

2. The nonaqueous electrolyte secondary battery according to claim 1, wherein a BET specific surface area of said conductive material is 1.0 m²/g or more.

3. The nonaqueous electrolyte secondary battery according to claim 1, wherein said inorganic particle is rutile type titanium oxide or aluminum oxide.

4. The nonaqueous electrolyte secondary battery according to claim 1, wherein a thickness of said inorganic particle layer is 4 μm or less.

5. The nonaqueous electrolyte secondary battery according to claim 1, wherein a content of the binder in said inorganic particle layer is 30 parts by weight or less with respect to 100 parts by weight of the total of said inorganic particle and said conductive material.

6. The nonaqueous electrolyte secondary battery according to claim 1, wherein an average particle diameter of said inorganic particle is larger than an average pore size of said separator.

7. The nonaqueous electrolyte secondary battery according to claim 1, wherein a content of said conductive material in said inorganic particle layer is within a range of 0.1 to 10% by weight of the total amount of said inorganic particle and said conductive material.

8. The nonaqueous electrolyte secondary battery according to claim 1, wherein said positive active material has a layered structure.

9. The nonaqueous electrolyte secondary battery according to claim 1, wherein charge is performed in such a way that the end-of-charge potential of said positive electrode becomes 4.35 V (vs. Li/Li⁺) or more.

10. The nonaqueous electrolyte secondary battery according to claim 2, wherein charge is performed in such a way that the end-of-charge potential of said positive electrode becomes 4.35 V (vs. Li/Li⁺) or more.

11. The nonaqueous electrolyte secondary battery according to claim 3, wherein charge is performed in such a way that the end-of-charge potential of said positive electrode becomes 4.35 V (vs. Li/Li⁺) or more.

12. The nonaqueous electrolyte secondary battery according to claim 4, wherein charge is performed in such a way that the end-of-charge potential of said positive electrode becomes 4.35 V (vs. Li/Li⁺) or more.

13. The nonaqueous electrolyte secondary battery according to claim 5, wherein charge is performed in such a way that the end-of-charge potential of said positive electrode becomes 4.35 V (vs. Li/Li⁺) or more.

14. The nonaqueous electrolyte secondary battery according to claim 6, wherein charge is performed in such a way that the end-of-charge potential of said positive electrode becomes 4.35 V (vs. Li/Li⁺) or more.

15. The nonaqueous electrolyte secondary battery according to claim 7, wherein charge is performed in such a way that the end-of-charge potential of said positive electrode becomes 4.35 V (vs. Li/Li⁺) or more.

16. The nonaqueous electrolyte secondary battery according to claim 8, wherein charge is performed in such a way that the end-of-charge potential of said positive electrode becomes 4.35 V (vs. Li/Li⁺) or more.
